(19) United States
(12) Patent Application Publication
(10) Pub. No.: US 2023/0276786 A1
(43) Pub. Date: Sep. 7, 2023

(54) Hunting Cart Assembly

(71) Applicant: James Wagner, Grantsburg, WI (US)

(72) Inventor: James Wagner, Grantsburg, WI (US)

(21) Appl. No.: 17/685,553

(22) Filed: Mar. 3, 2022

(51) Int. Cl. A01M 31/00; B62B 5/00; B62B 1/10; B62B 5/06

(52) U.S. Cl. CPC A01M 31/006; B62B 5/004; B62B 5/0043; B62B 1/10; B62B 5/06; B62B 5/0069; B62B 2202/42

(57) ABSTRACT

A hunting cart assembly includes a cart that includes a first frame which is pivotally coupled to a second frame such that the cart is positionable between a folded position for storage and an unfolded position for utilization. A pair of wheels is each rotatably disposed on the second frame to roll along a support surface. A pair of motors is each integrated into a respective one of the wheels. Each of the motors rotates the respective wheel in a first direction when the motors are turned on to urge the cart along the support surface. A lever is pivotally coupled to a respective one of the handles and the lever is in communication with the pair of motors. Each of the motors is turned on when the lever is urged into an actuating condition and each of the motors is turned off when the lever is biased into a de-actuating condition.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cart devices and more particularly pertains to a new cart device for transporting large game out of a hunting area. The device includes a cart which comprises a first frame hingedly coupled to a second frame for positioning the cart between a folded position and an unfolded position. The device includes a pair of wheels rotatably disposed on the cart and a pair of motors integrated into a respective one of the wheels. Each of the motors rotates the respective wheel when the motors are turned on for urging the cart along a support surface. The device includes a lever that is movably integrated into the cart and which is in communication with the pair of motors. Each of the motors is turned on when the lever is actuated.

### (2) Description of Related Art Including Information Disclosed Under 37 CFR 1.97 and 1.98

The prior art relates to cart devices including a motorized cart which includes a single wheel, centrally located on a gurney and a motor which drives the wheel. The prior art discloses a game gurney which includes a pair of arms which pivotally engage a bas such that the arms form a triangle with the base and a pair of wheels rotatably coupled to the base. The prior art discloses a collapsible game cart which includes a frame that has a telescopic section and a pair of wheels rotatably coupled to the frame for transporting hunted game. The prior art discloses a carcass cart which includes a platform, a lifting arm pivotally coupled to the platform and a chain coupled to the lifting arm which can be attached to an animal thereby facilitating the lifting arm to lift an animal carcass onto the platform. The prior art discloses a motorized cart which includes a plurality of wheels, a motor for driving the wheels and a bowl disposed on the motorized cart for containing cargo. The prior art discloses a motorized game cart which includes a mesh frame, a single wheel rotatably disposed on the mesh frame and a motor for rotating the single wheel.

### BRIEF SUMMARY OF THE INVENTION

An embodiment of the disclosure meets the needs presented above by generally comprising a cart that includes a first frame which is pivotally coupled to a second frame such that the cart is positionable between a folded position for storage and an unfolded position for utilization. A pair of wheels is each rotatably disposed on the second frame to roll along a support surface. A pair of motors is each integrated into a respective one of the wheels. Each of the motors rotates the respective wheel in a first direction when the motors are turned on to urge the cart along the support surface. A lever is pivotally coupled to a respective one of the handles and the lever is in communication with the pair of motors. Each of the motors is turned on when the lever is urged into an actuating condition and each of the motors is turned off when the lever is biased into a de-actuating condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hunting cart assembly according to an embodiment of the disclosure.

FIG. 2 is a front view of an embodiment of the disclosure.

FIG. 3 is a left side view of an embodiment of the disclosure.

FIG. 4 is a back view of an embodiment of the disclosure.

FIG. 5 is a cross sectional view taken along line 5-5 of FIG. 2 of an embodiment of the disclosure.

FIG. 6 is a side view of an embodiment of the disclosure.

FIG. 7 is a perspective in-use view of an embodiment of the disclosure.

### DETAILED DESCRIPTION OF THE INVENTION

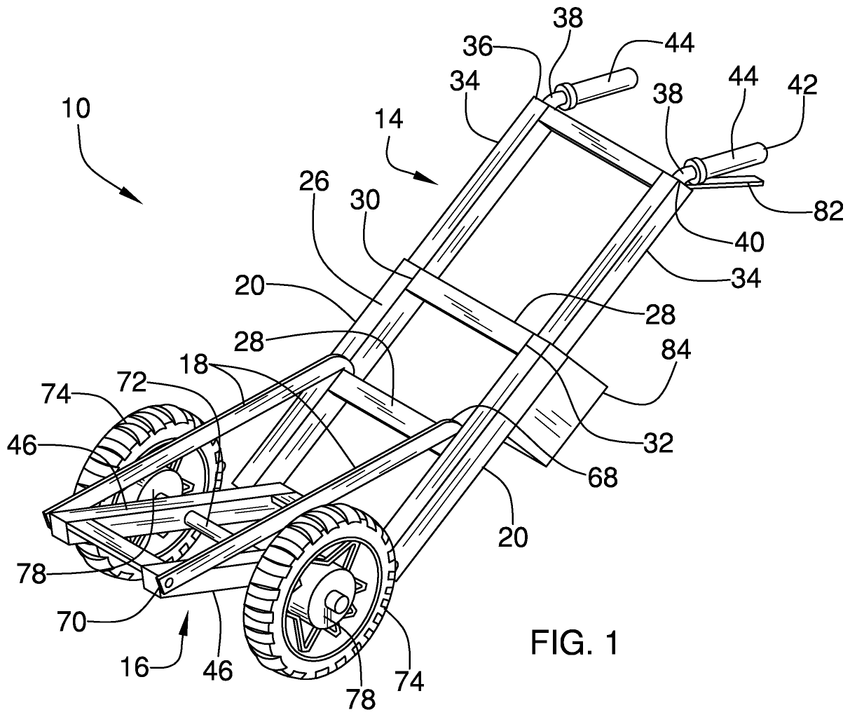

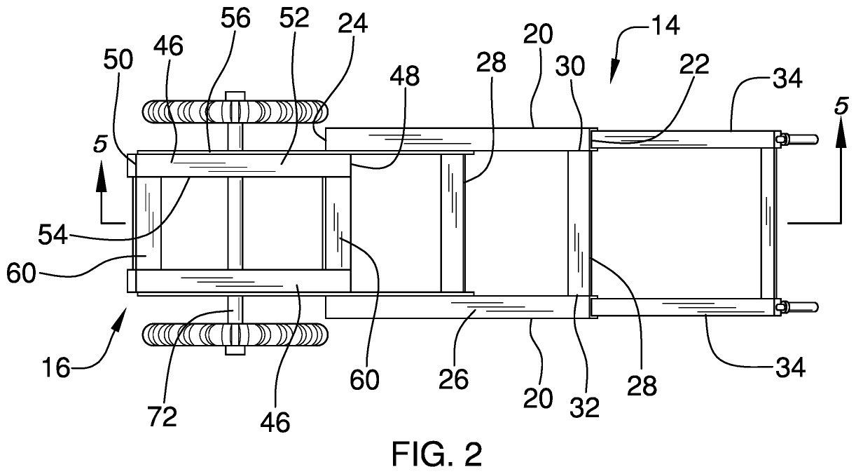

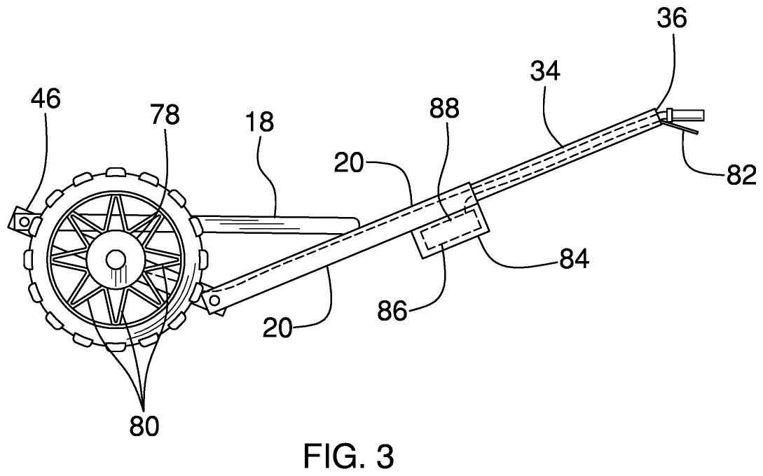

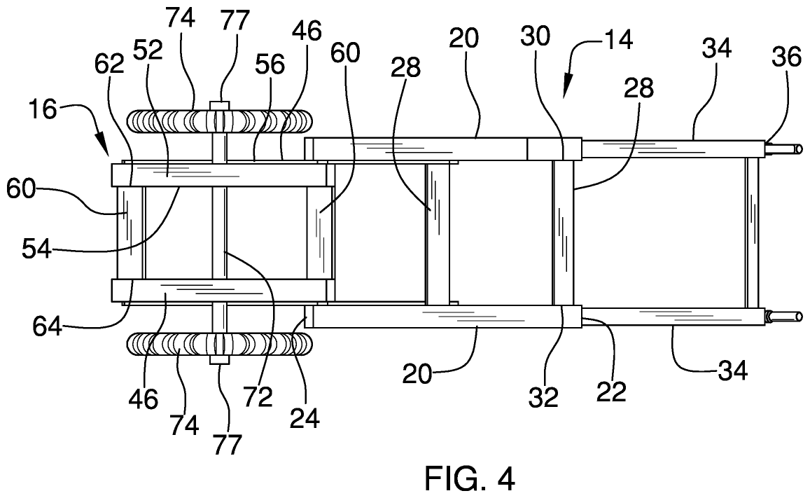

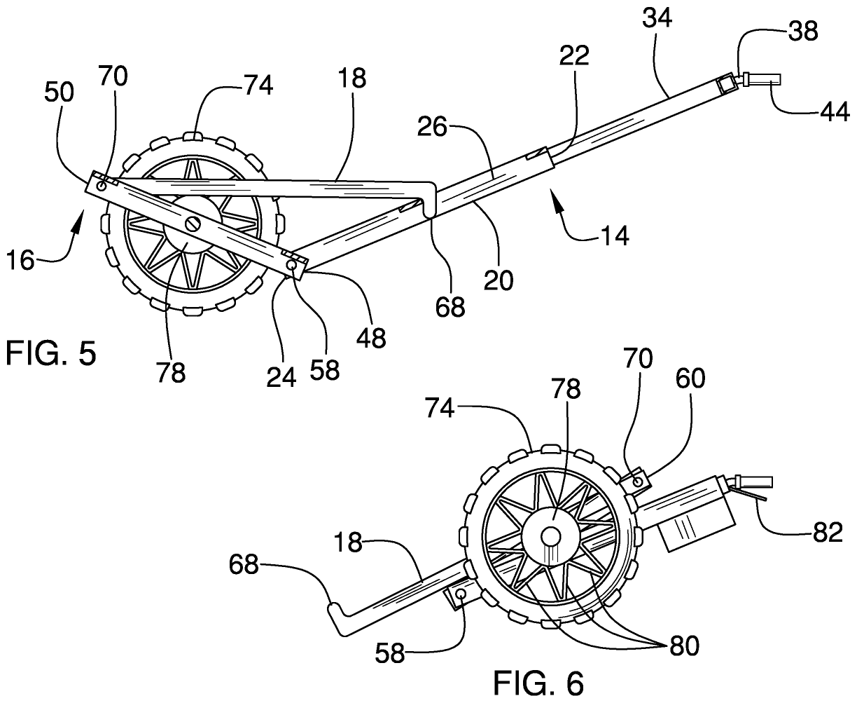

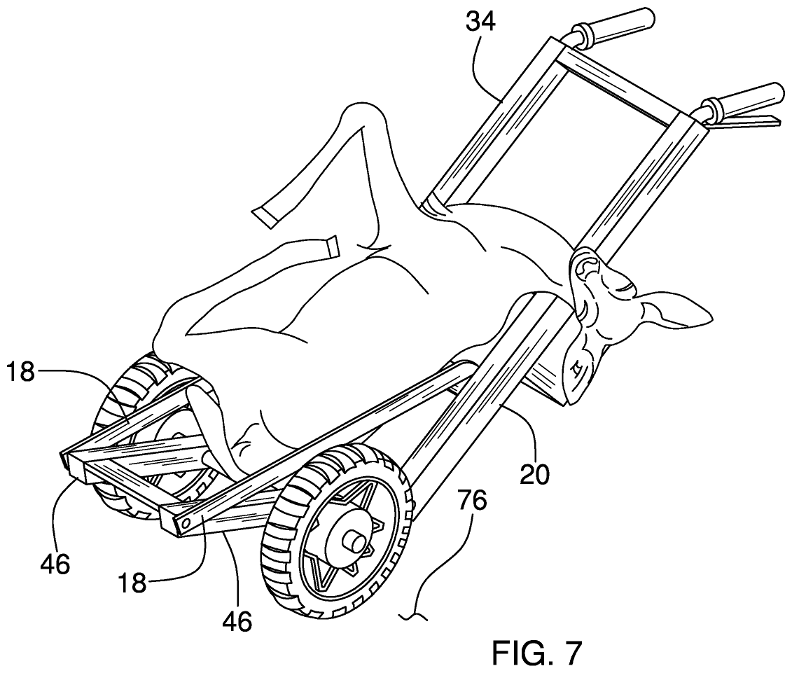

With reference now to the drawings, and in particular to FIGS. 1 through 7 thereof, a new cart device embodying the principles and concepts of an embodiment of the disclosure and generally designated by the reference numeral 10 will be described.

As best illustrated in FIGS. 1 through 7, the hunting cart assembly 10 generally comprises a cart 12 which includes a first frame 14 that is pivotally coupled to a second frame 16 such that the cart 12 is positionable between a folded position for storage and an unfolded position for utilization. The second frame 16 includes a pair of arms 18 that is each pivotally disposed on the second frame 16. Each of the arms 18 releasably engages the first frame 14 at a predetermined location for retaining the cart 12 in the unfolded position. The first frame 14 comprises a pair of tubes 20 that each of the tubes 20 has a first end 22, a second end 24 and an outer wall 26 extending between the first end 22 and the second end 24.

The first frame 14 includes a plurality of first cross members 28 which each has a first end 30 and a second end 32. Each of the first end 30 and the second end 32 of each of the first cross members 28 is coupled to the outer wall 26 of a respective one of the tubes 20. Furthermore, the first cross members 28 are spaced apart from each other and are distributed between the first end 22 and the second end 24 of the tubes 20. The first frame 14 includes a pair of first members 34 and the first end 22 of each of the tubes 20 slidably receives a respective one of the first members 34 for slidably adjusting an overall length of the first frame 14. Additionally, each of the first members 34 has a distal end 36 with respect to the first end 22 of the tubes 20.

The first frame 14 includes a pair of handles 38 which each has a coupled end 40 and a free end 42. The coupled end 40 of each of the handles 38 is coupled to the distal end 36 of a respective one of the first members 34. Each of the handles 38 is curved between the coupled end 40 and the free end 42 thereby facilitating each of the handles 38 to be gripped. A pair of grips 44 is each positioned around a respective one of the handles 38 and each of the grips 44 is comprised of a resiliently compressible material thereby enhancing comfort for gripping. Additionally, each of the grips 44 extends from the free end 42 of the respective handle 38 toward the coupled end 40 of the respective handle 38.

The second frame 16 comprises a pair of second members 46 that each has a primary end 48, a secondary end 50 and an exterior wall 52 extending between the primary end 48 and the secondary end 50. The exterior wall 52 of each of the second members 46 has an inwardly facing side 54 and an outwardly facing side 56. The outwardly facing side 56 of the exterior wall 52 of each of the second members 46 has a pivot point 58 that is located adjacent to the primary end 48. The pivot point 58 on each of the second members 46 pivotally engages the outer wall 26 of a respective one of the tubes 20 at a point located adjacent to the second end 24 of the respective tube 20.

The second frame 16 includes a plurality of second cross members 60 which each has a primary end 62 and a secondary end 64. Each of the primary end 62 and the secondary end 64 of each of the second cross members 60 is coupled to the inwardly facing side 54 of the exterior wall 52 of a respective one of the second members 46. The second cross members 60 are spaced apart from each other and are distributed between the primary end 48 and the secondary end 50 of the second members 46. Each of the arms 18 has a coupled end 66 and a hooked end 68, and each of the arms 18 has a pivot point 70 that is located adjacent to the coupled end 40 of the arms 18. The pivot point 70 on each of the arms 18 pivotally engages the outwardly facing side 56 of the exterior wall 52 of a respective one of the second members 46. Additionally, each of the arms 18 is curved adjacent to the hooked end 68 such that the hooked end 68 is directed toward the coupled end 40.

The hooked end 68 of each of the arms 18 engages a respective one of the first members 34 associated with the first frame 14 when the cart 12 is in the unfolded position. In this way the second frame 16 is retained at a preferred angle with respect to the first frame 14. Conversely, the second frame 16 lies against the first frame 14 when the cart 12 is in the folded position and each of the arms 18 extends outwardly beyond the second end 24 of the tubes 20 when the cart 12 is in the folded position. An axle 72 extends through each of the second members 46 of the second frame 16 and the axle 72 is centrally positioned between the primary end 48 and the secondary end 50 of the second members 46.

A pair of wheels 74 is each rotatably disposed on the second frame 16 to roll along a support surface 76. The support surface 76 may be ground or other uneven, horizontal support surface. Each of the wheels 74 is positioned adjacent to opposing ends 77 of the axle 72 such that each of the wheels 74 is spaced outwardly from the outwardly facing side 56 of the exterior wall 52 of a respective one of the second members 46 of the second frame 16. Each of the wheels 74 may include rubber tires and each of the wheels 74 may have a diameter of at least 12.0 inches thereby facilitating the wheels 74 to roll over small obstacles, such as rocks and tree branches, as well as to traverse uneven terrain.

A pair of motors 78 is provided and each of the motors 78 is integrated into a respective one of the wheels 74. Each of the motors 78 rotates the respective wheel 74 in a first direction when the motors 78 are turned on to urge the cart 12 along the support surface. Each of the motors 78 is positioned around the axle 72 such that each of the motors 78 engages the axle 72. Each of the wheels 74 includes spokes 80 and each of the spokes 80 on each of the wheels 74 is attached to a respective one of the motors 78 such that each of the wheels 74 is rotated on the axle 72 when the motors 78 are turned on. Each of the motors 78 may comprise an electric motor or the like and each of the motors 78 may have sufficient torque to facilitate the cart 12 to transport large game 81, such as whitetail deer or other similarly sized animal, over uneven and hilly terrain.

A lever 82 is pivotally coupled to a respective one of the handles 38 and the lever 82 is in communication with the pair of motors 78. Each of the motors 78 is turned on when the lever 82 is urged into an actuating condition. The lever 82 is biased into a de-actuating condition and each of the motors 78 is turned off when the lever 82 is in the de-actuating condition. Each of the motors 78 may be actuated into between a minimum rotational speed and a maximum rotational which corresponds to the degree to which the lever 82 is urged into the actuating condition. In this way the speed of the cart 12 can be controlled by urging the lever 82 between a minimum actuation and a maximum actuation.

A battery housing 84 is provided and the battery housing 84 is coupled to a respective one of the tubes 20 of the first frame 14. A power supply 86 is positioned within the battery housing 84 and the lever 82 is electrically coupled to the power supply 86. Additionally, the power supply 86 is electrically coupled to each of the motors 78 and the power supply 86 comprises at least one battery 88. Furthermore, the battery 88 may comprise a 36.0 volt battery or other battery which has sufficient capacity to ensure the motors 78 are capable of producing the necessary torque for transporting large game.

In use, the cart 12 is positioned in the unfolded position and each of the arms 18 is engaged to the respective first members 34 of the first frame 14 to retain the cart 12 in the unfolded position. In this way the large game 81 can be laid on the first frame 14 and the second frame 16 when the large game 81 has been harvested during hunting. The handles 38 are gripped and the lever 82 is urged into the actuating condition to turn on the motors 78. In this way each of the wheels 74 is rotated thereby facilitating the large game 81 to be transported to a desired location with minimal effort from a user. The arms 18 are released from the respective first members 34 and the cart 12 is positioned in the folded position for storing the cart 12 or to transport the cart 12 in a vehicle when the large game 81 has been transported to the desired location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hunting cart assembly for transporting hunted game out of a hunting area, said assembly comprising:
a cart comprising a first frame being pivotally coupled to a second frame such that said cart is positionable between a folded position for storage and an unfolded position for utilization, said second frame including a pair of arms each being pivotally disposed on said second frame, each of said arms releasably engaging said first frame at a predetermined location for retaining said cart in said unfolded position;
a pair of wheels, each of said wheels being rotatably disposed on said second frame wherein each of said wheels is configured to roll along a support surface;
a pair of motors, each of said motors being integrated into a respective one of said wheels, each of said motors rotating said respective wheel in a first direction when said motors are turned on wherein each of said motors is configured to urge said cart along the support surface; and
a lever being pivotally coupled to a respective one of said handles, said lever being in communication with said pair of motors, each of said motors being turned on when said lever is urged into an actuating condition, said lever being biased into a de-actuating condition, each of said motors being turned off when said lever is in said de-actuating condition.

2. The assembly according to claim 1, wherein said first frame comprises:
a pair of tubes, each of said tubes having a first end, a second end and an outer wall extending between said first end and said second end;
a plurality of first cross members, each of said first cross members having a first end and a second end, each of said first end and said second end of each of said first cross members being coupled to said outer wall of a respective one of said tubes, said first cross members being spaced apart from each other and being distributed between said first end and said second end of said tubes; and
a pair of first members, said first end of each of said tubes slidably receiving a respective one of said first members for slidably adjusting an overall length of said first frame, each of said first members having a distal end with respect to said first end of said tubes.

3. The assembly according to claim 2, wherein said first frame comprises:
a pair of handles, each of said handles having a coupled end and a free end, said coupled end of each of said handles being coupled to said distal end of a respective one of said first members, each of said handles being curved between said coupled end and said free end thereby facilitating each of said handles to be gripped; and
a pair of grips, each of said grips being positioned around a respective one of said handles, each of said grips being comprised of a resiliently compressible material thereby enhancing comfort for gripping, each of said grips extending from said free end of said respective handle toward said coupled end of said respective handle.

4. The assembly according to claim 2, wherein said second frame comprises:
a pair of second members, each of said second members having a primary end, a secondary end and an exterior wall extending between said primary end and said secondary end, said exterior wall of each of said second members having an inwardly facing side and an outwardly facing side, said outwardly facing side of said exterior wall of each of said second members having a pivot point being located adjacent to said primary end, said pivot point on each of said second members pivotally engaging said outer wall of a respective one of said tubes at a point located adjacent to said second end of said respective tube; and
a plurality of second cross members, each of said second cross members having a primary end and a secondary end, each of said primary end and said secondary end of each of said second cross members being coupled to said inwardly facing side of said exterior wall of a respective one of said second members, said second cross members being spaced apart from each other and being distributed between said primary end and said secondary end of said second members.

5. The assembly according to claim 4, wherein each of said arms has a coupled end and a hooked end, each of said arms having a pivot point being located adjacent to said coupled end of said arms, said pivot point on each of said arms pivotally engaging said outwardly facing side of said exterior wall of a respective one of said second members, each of said arms being curved adjacent to said hooked end such that said hooked end is directed toward said coupled end.

6. The assembly according to claim 5, wherein:
said hooked end of each of said arms engages a respective one of said first members associated with said first frame when said cart is in said unfolded position thereby retaining said second frame at a preferred angle with respect to said first frame; and
said second frame lies against said first frame when said cart is in said folded position having each of said arms extending outwardly beyond said second end of said tubes when said cart is in said folded position.

7. The assembly according to claim 4, wherein:
said assembly includes an axle extending through each of said second members of said second frame, said axle being centrally positioned between said primary end and said secondary end of said second members; and
each of said wheels is positioned adjacent to opposing ends of said axle such that each of said wheels is spaced outwardly from said outwardly facing side of said exterior wall of a respective one of said second members of said second frame.

8. The assembly according to claim 8, wherein each of said motors is positioned around said axle such that each of said motors engages said axle, each of said wheels including spokes, each of said spokes on each of said wheels being attached to a respective one of said motors such that each of said wheels is rotated on said axle when said motors are turned on.

9. The assembly according to claim 2, further comprising:
a battery housing being coupled to a respective one of said tubes of said first frame; and
a power supply being positioned within said battery housing, said lever being electrically coupled to said power supply, said power supply being electrically coupled to each of said motors, said power supply comprising at least one battery.

10. A hunting cart assembly for transporting hunted game out of a hunting area, said assembly comprising:
a cart comprising a first frame being pivotally coupled to a second frame such that said cart is positionable between a folded position for storage and an unfolded position for utilization, said second frame including a pair of arms each being pivotally disposed on said second frame, each of said arms releasably engaging said first frame at a predetermined location for retaining said cart in said unfolded position, said first frame comprising:
a pair of tubes, each of said tubes having a first end, a second end and an outer wall extending between said first end and said second end;
a plurality of first cross members, each of said first cross members having a first end and a second end, each of said first end and said second end of each of said first cross members being coupled to said outer wall of a respective one of said tubes, said first cross members being spaced apart from each other and being distributed between said first end and said second end of said tubes;
a pair of first members, said first end of each of said tubes slidably receiving a respective one of said first members for slidably adjusting an overall length of said first frame, each of said first members having a distal end with respect to said first end of said tubes;
a pair of handles, each of said handles having a coupled end and a free end, said coupled end of each of said handles being coupled to said distal end of a respective one of said first members, each of said handles being curved between said coupled end and said free end thereby facilitating each of said handles to be gripped; and
a pair of grips, each of said grips being positioned around a respective one of said handles, each of said grips being comprised of a resiliently compressible material thereby enhancing comfort for gripping, each of said cushions extending from said free end of said respective handle toward said coupled end of said respective handle;
said second frame comprising:
a pair of second members, each of said second members having a primary end, a secondary end and an exterior wall extending between said primary end and said secondary end, said exterior wall of each of said second members having an inwardly facing side and an outwardly facing side, said outwardly facing side of said exterior wall of each of said second members having a pivot point being located adjacent to said primary end, said pivot point on each of said second members pivotally engaging said outer wall of a respective one of said tubes at a point located adjacent to said second end of said respective tube; and
a plurality of second cross members, each of said second cross members having a primary end and a secondary end, each of said primary end and said secondary end of each of said second cross members being coupled to said inwardly facing side of said exterior wall of a respective one of said second members, said second cross members being spaced apart from each other and being distributed between said primary end and said secondary end of said second members;
each of said arms has a coupled end and a hooked end, each of said arms having a pivot point being located adjacent to said coupled end of said arms, said pivot point on each of said arms pivotally engaging said outwardly facing side of said exterior wall of a respective one of said second members, each of said arms being curved adjacent to said hooked end such that said hooked end is directed toward said coupled end, said hooked end of each of said arms engaging a respective one of said first members associated with said first frame when said cart is in said unfolded position thereby retaining said second frame at a preferred angle with respect to said first frame, said second frame lying against said first frame when said cart is in said folded position having each of said arms extending outwardly beyond said second end of said tubes when said cart is in said folded position;
an axle extending through each of said second members of said second frame, said axle being centrally positioned between said primary end and said secondary end of said second members;
a pair of wheels, each of said wheels being rotatably disposed on said second frame wherein each of said wheels is configured to roll along a support surface, each of said wheels being positioned adjacent to opposing ends of said axle such that each of said wheels is spaced outwardly from said outwardly facing side of said exterior wall of a respective one of said second members of said second frame;
a pair of motors, each of said motors being integrated into a respective one of said wheels, each of said motors rotating said respective wheel in a first direction when said motors are turned on wherein each of said motors is configured to urge said cart along the support surface, each of said motors being positioned around said axle such that each of said motors engages said axle, each of said wheels including spokes, each of said spokes on each of said wheels being attached to a respective one of said motors such that each of said wheels is rotated on said axle when said motors are turned on;
a lever being pivotally coupled to a respective one of said handles, said lever being in communication with said pair of motors, each of said motors being turned on when said lever is urged into an actuating condition, said lever being biased into a de-actuating condition, each of said motors being turned off when said lever is in said de-actuating condition;
a battery housing being coupled to a respective one of said tubes of said first frame; and
a power supply being positioned within said battery housing, said lever being electrically coupled to said power supply, said power supply being electrically coupled to each of said motors, said power supply comprising at least one battery.
